(19) United States
(12) Patent Application Publication
(10) Pub. No.: US 2026/0278380 A1
(43) Pub. Date: Sep. 17, 2026

(54) AUTOMATED AI MODEL OPTIMIZATION FOR MICROCONTROLLERS

(71) Applicant: Infineon Technologies Americas Corp., El Segundo, CA (US)

(72) Inventor: Niall LYONS, Irvine, CA (US)

(73) Assignee: Infineon Technologies Americas Corp., El Segundo, CA (US)

(21) Appl. No.: 19/563,983

(22) Filed: Mar. 11, 2026

Related U.S. Application Data
(60) Provisional application No. 63/770,887, filed on Mar. 12, 2025.

(51) Int. Cl. G06N 3/082; G06N 3/0495

(52) U.S. Cl. CPC G06N 3/082; G06N 3/0495

(57) ABSTRACT

A method of AI model optimization is disclosed. The method can include obtaining a hardware profile of a microcontroller unit (MCU); deriving a plurality of constraints based on the hardware profile; training a baseline AI model using a training dataset, to produce a trained model; performing a first pruning on the trained model, to produce a first pruned model; retraining the first pruned model using the training dataset, to produce a retrained pruned model; performing a second pruning on the retrained pruned model, to produce a second pruned model; and retraining the second pruned model to produce a quantized pruned model.

### CROSS-REFERENCE TO RELATED APPLICATION

This application claims the benefit of U.S. Provisional Application No. 63/770,887 filed on Mar. 12, 2025, the disclosure of which is incorporated herein by reference.

### TECHNICAL FIELD

Embodiments of the disclosure relate generally to microcontrollers or microcontroller units (MCUs). More particularly, embodiments of the disclosure relate to the automation of artificial intelligence (AI) model optimization for MCUs.

### BACKGROUND

Deploying AI models on microcontrollers presents significant challenges. For instance, memory is limited (often a few hundred kilobytes of random access memory (RAM)/flash memory), compute is constrained as MCUs lack the high-performance clock speed or operating frequency (gigahertz) of central processing units (CPUs) or graphics processing units (GPUs) of cloud servers, and power budgets are generally limited for battery-operated devices. For example, traditional computer vision AI models, which may be tens or hundreds of megabytes and require billions of operations, must be carefully optimized to fit and run on such tiny hardware. This has historically limited MCUs to simple ML tasks such as basic sensor analytics.

Certain MCUs, such as Infineon PSOC^{TM} Edge MCUs, are specifically optimized for on-device AI. They integrate a high-performance processor (e.g., Arm Cortex-M55 core with digital signal processing (DSP) extensions for machine learning (ML)) and a neural processing unit (NPU) (e.g., Ethos-U55 microNPU) to massively speed up neural network inference in a power-efficient manner. In fact, an NPU can provide up to a 480x improvement in ML throughput compared to using a reduced instruction set computer (RISC) ARM processor alone. This enables complex vision tasks, such as human detection in images, to run in real time on a microcontroller-class device. The synergy of software and MCU hardware makes it feasible to deploy advanced computer vision at the edge. The benefits are multifold:
a) Low latency - decisions (e.g. detecting a person at the door) are made on-device in milliseconds, without the round-trip delay of cloud processing;
b) Enhanced privacy - e.g., camera data does not need to leave the device, since inference happens locally;
c) Energy efficiency - purpose-built NPUs execute INT8 operations at a fraction of the power of general CPUs, enabling battery-powered AI gadgets; and
d) Cost-effectiveness - high-volume MCUs are inexpensive, allowing AI features to be added to consumer products (e.g., smart cameras, doorbells, appliances, etc.) with minimal bill of materials (BOM) increase.

Unfortunately, deploying AI models to MCUs has historically been a manual, expert-only process. Between a trained model and a deployed embedded model, there is no automated, hardware-aware optimization bridge.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a system architecture of an automated AI model optimization system according to an embodiment.

FIGS. 2A-2B are block diagrams illustrating an example automated AI model optimization system according to an embodiment.

FIG. 3 is a flow diagram illustrating an example process of a closed loop AI model optimization according to an embodiment.

FIG. 4 is a sequence diagram illustrating actions for quantization aware training (QAT) in an automated AI model optimization system according to an embodiment.

FIG. 5 is a flow diagram illustrating an example process of verifying NPU operator compatibility according to an embodiment.

FIG. 6 is a block diagram illustrating a data processing system according to an embodiment.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to some embodiments, an automated, hardware-specification-driven optimization loop for AI models targeting resource-constrained embedded processors is provided. The system may take a hardware profile of a specific MCU, including memory budget, storage capacity, NPU architecture, supported operator set, and compute bandwidth, as its primary input. The system then applies regularized base training to pre-condition the model for pruning, followed by a two-stage structured pruning (global threshold pruning with accuracy recovery, then per-layer sparsity targeting derived from the hardware profile), quantization-aware retraining, and hardware profiling in a closed loop until the model provably satisfies all hardware constraints. An automated NPU operator coverage check may verify that 100% of operations execute on the hardware accelerator. The output is a hardware-bound model certified for a specific identifier, e.g., stock keeping unit (SKU) of an MCU, with a documented memory map, performance certificate, and operator coverage report. This technique can achieve 97% in model size reduction and 10x latency improvement with less than 2% accuracy loss, entirely without human intervention once the hardware profile and training dataset are provided.

According to one aspect, methods, non-transitory computer readable storage media, and systems for AI model optimization are described. In an embodiment, a hardware profile of a microcontroller unit (MCU) may be obtained. A plurality of constraints may be derived based on the hardware profile. A baseline AI model may be trained using a training dataset, to produce a trained model. A first pruning may be performed on the trained model, to produce a first pruned model. The first pruned model may be retrained using the training dataset, to produce a retrained pruned model. A second pruning may be performed on the retrained pruned model, to produce a second pruned model. The second pruned model may be retrained to produce a quantized pruned model.

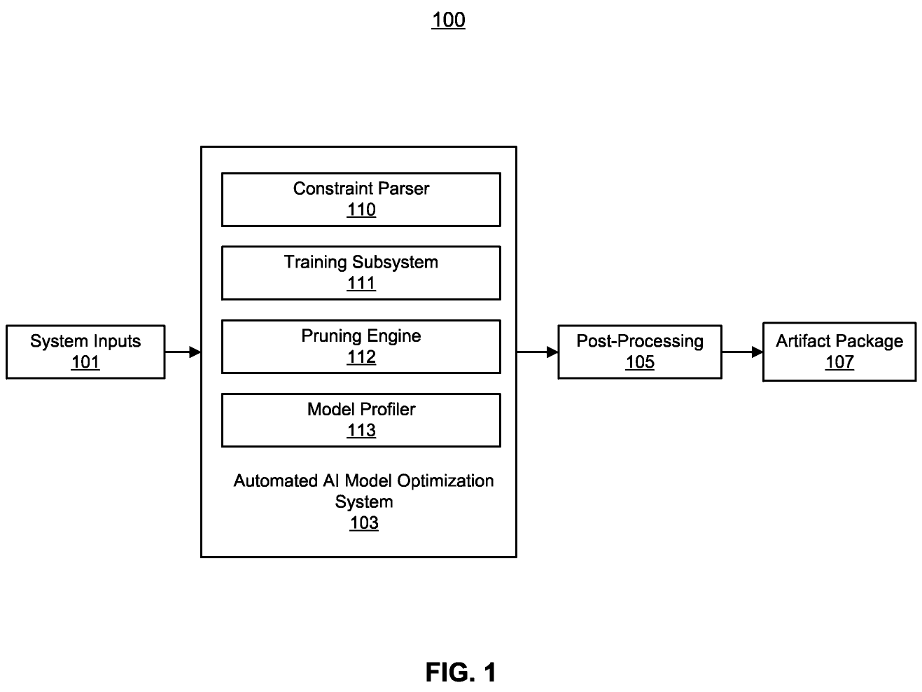

FIG. 1 is a block diagram illustrating a system architecture of an automated AI model optimization system according to an embodiment. Referring to FIG. 1, system architecture 100 includes, but is not limited to, an automated AI model optimization system 103 and a post-processing unit 105. In some embodiments, AI model optimization system 103 and post-processing unit 105 may reside on any kind of servers or a cluster of servers, such as AI servers, Web or cloud servers, application servers, backend servers, or a combination thereof. As shown, AI model optimization system 103 may include, but not limited to, a constraint parser 110, a training subsystem 111, a pruning engine 112 and a model profiler 113.

AI model optimization system 103 may obtain (e.g., receive or retrieve) system inputs 101 that may include a hardware profile or specification of a specific MCU, a baseline AI model, and/or a training dataset. The hardware profile may include, for example, memory budget (e.g., static random access memory (SRAM) budget), storage capacity (e.g., flash capacity), NPU architecture (e.g., NPU type, NPU multiply-accumulate (MAC) units, etc.), supported operator set, clock frequency, compute bandwidths (e.g., memory bandwidth and storage bandwidth), etc. The hardware profile may be provided to constraint parser 110 to derive optimization targets or constraints from the hardware profile. For example, constraint parser 110 may programmatically parse the hardware profile to derive the optimization targets or constraints. The derived optimization constraints may include a maximum activation tensor budget, a maximum model weight budget, supported operation set and tiling strategy, a throughput constraint, a latency budget, an activation scheduling, and/or a constant memory placement.

Correspondingly, training subsystem 111 may obtain (e.g., receive or retrieve) a baseline AI model and a training dataset, and train the baseline AI model using the training data set. The baseline AI model and training dataset may also be part of system inputs 101. In some embodiments, the baseline AI model may be a machine learning model/algorithm (e.g., deep learning architectures such as deep neural networks, convolutional neural networks, deep belief networks, recurrent neural networks, etc.). The baseline AI model may be pretrained on an image database or with a public dataset of images to initialize the AI model with pretrained weights. In an example, the training data set may be a dataset of images annotated with rich information for computer vision that may include labels, object bounding boxes, segmentation masks, and/or visual relationships. It can be used, for example, to train the AI model to predict object bounding boxes and confidence scores on dense grid over an image for object detection and classification. While the foregoing examples use datasets of images to pretrain and train the AI model, in other embodiments, any types of datasets can be used to pretrain and train the AI model.

In an embodiment, training subsystem 111 may apply regularization to the trained AI model to pre-condition the model for pruning. For example, training subsystem 111 may apply an L1 regularization to reduce overfitting in the trained AI model by penalizing the absolute size of the regression coefficients. Subsequently, the pre-conditioned model may be provided to pruning engine 112 to perform a two-stage structured pruning. For example, to squeeze or fit the AI model into an MCU’s optimization (resource) constraints, model pruning may be performed to eliminate weights (and/or neurons/filters) that contribute little to the model’s predictions, thereby reducing the model size and speeding up inference. Structured pruning, such as channel pruning, can remove entire convolutional filters (and corresponding feature map channels). This is hardware-friendly, as it shrinks the layers of the AI model rather than creating sparse matrices.

Accordingly, pruning engine 112 may perform a two-stage pruning process to methodically trim the AI model while preserving accuracy. For example, in the first stage, pruning engine 112 may apply a weight magnitude threshold pruning to the AI model to remove the most insignificant weights across all layers of the model and produce a first pruned AI model. The first pruned AI model may then be retrained by training subsystem 111 to produce a first retrained pruned AI model. In the second stage, pruning engine 112 may perform a finer, layer-wise pruning, with more aggressive targets, on the first retrained model to produce a second pruned AI model. The second pruned AI model may then be retrained (e.g., using QAT) to produce a second retrained pruned AI model (e.g., pruned and quantized model). Accordingly, this two-stage process avoids substantial pruning all at once, which could irreversibly degrade the model. By pruning gradually and allowing the model to recover accuracy in between via retraining, model performance can be maintained while drastically reducing complexity. Aspects of the two-stage pruning process will be described in more detail herein below.

In an embodiment, model profiler 113 may profile the second retrained pruned AI model to provide information about how efficiently the second retrained pruned AI model may run on a target MCU. For example, model profiler 113 may analyze the second retrained pruned AI model’s performance, resource utilization, and behavior during training or inference to identify bottlenecks. Model profiler 113 may measure metrics like resource usage (e.g., NPU/CPU usage), memory consumption, inference latency, throughput, and/or operator (op) set compatibility check. Based on the metrics, system 103 may determine whether all optimization constraints are satisfied (i.e., the model fits the hardware profile of the MCU). If so, the second retrained pruned AI model may be provided to post-processing module 105. Otherwise, the second retrained pruned AI model may be returned or looped back to pruning engine 112 to again perform the second stage pruning.

Post-processing module 105 may optimize the second retrained pruned AI model for deployment on a target NPU of the MCU. For example, post-processing module 105 may convert the model into a highly efficient, custom operator command streams. Module 105 may then verify that the entirety (e.g., 100%) of the operator command streams (model operations) are supported or covered by the target NPU. Note that not all model operations are supported by every NPU. If an op falls back to the CPU, latency target may not be met. If the model operations are not entirely covered by the target NPU, the optimized model may be returned or looped back to pruning engine 112 to again perform the second-stage pruning and retraining. In an embodiment, module 105 may also perform memory budget validation to ensure the size of the model operations (model size) is within the memory budget of the hardware profile. Post-processing module 105 may then perform hardware binding to bind the optimized model to the specific MCU and produce a final optimized model certified and tagged to an identifier, e.g., SKU, of the specific MCU. In some embodiments, the hardware binding may produce or generate an artifact package 107 certified for a specific identifier (e.g., SKU) of an MCU. Artifact package 107 may include a final optimized model, an operator coverage report, a performance certificate, and/or a memory map, as described in more detail herein below.

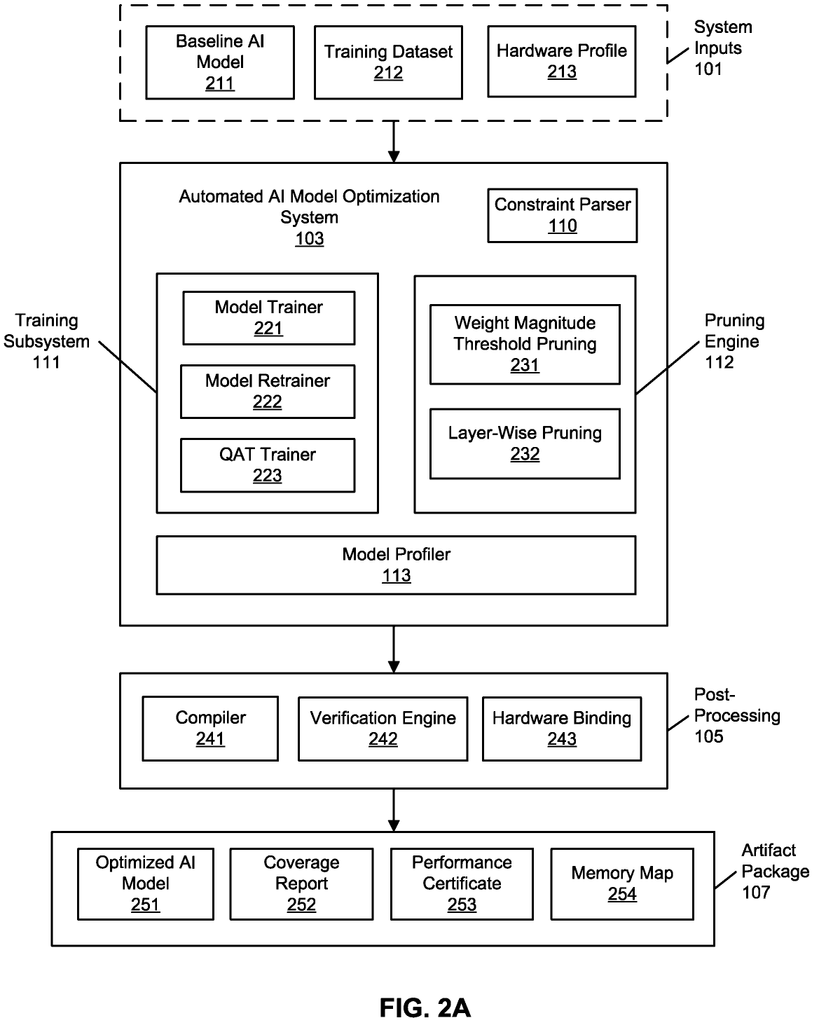

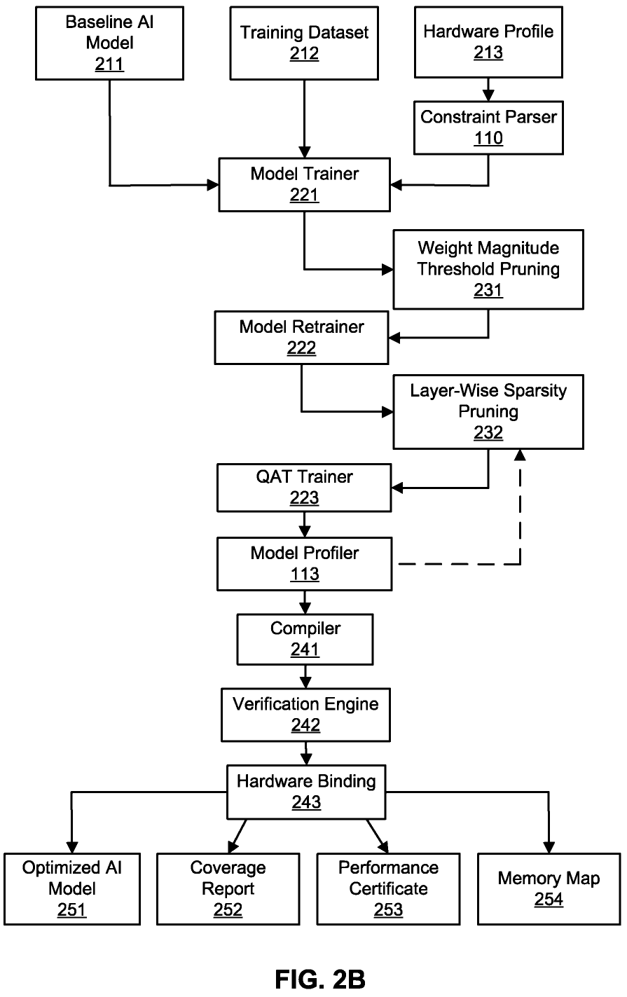

FIGS. 2A-2B are block diagrams illustrating an example automated AI model optimization system according to an embodiment. As previously described, automated AI model optimization system 103 may include constraint parser 110, training subsystem 111, pruning engine 112, and model profiler 113. As shown in FIG. 2A, training subsystem 111 may include a model trainer 221, a model retrainer 222, and a QAT trainer 223. Pruning engine 112 may include weight magnitude threshold pruning module 231 and layer-wise pruning module 232.

In an embodiment, constraint parser 110 may obtain (e.g., receive or retrieve) a hardware profile 213 and derive optimization constraints from the hardware profile 213. For example, constraint parser 110 may programmatically parse the hardware profile 213 to derive the optimization constraints. The hardware profile 213 may include, for example, memory budget (e.g., SRAM budget), storage capacity (e.g., flash capacity), NPU architecture (e.g., NPU type, NPU multiply-accumulate (MAC) units, etc.), supported operator set, clock frequency, compute bandwidths (e.g., memory bandwidth and storage bandwidth), etc. The derived optimization constraints may include a maximum activation tensor budget, a maximum model weight budget, supported operation set and tiling strategy, a throughput constraint, a latency budget, an activation scheduling, and/or a constant memory placement. Constraint parser 110 may then provide the optimization constraints to model trainer 221.

In an embodiment, model trainer 221 may obtain a baseline AI model 211 and a training dataset 212, and train AI model 211 using the training data set 212. In some embodiments, the AI model 211 may be a machine learning model/algorithm (e.g., deep learning architectures such as deep neural networks, convolutional neural networks, deep belief networks, recurrent neural networks, etc.). The AI model 211 may be pretrained on an image database (e.g., ImageNet) or with a public dataset of images (e.g., Google^{®} OpenImages) to initialize the AI model 211 with pretrained weights. In an example, the training data set may be a dataset of images annotated with rich information for computer vision that may include labels, object bounding boxes, segmentation masks, and/or visual relationships. It can be used, for example, to train the AI model 211 to predict object bounding boxes and confidence scores on dense grid over an image for object detection and classification. Note that while the foregoing examples use datasets of images to pretrain and train the AI model, in other examples, any types of datasets can be used to pretrain and train the AI model.

In an embodiment, model trainer 221 may apply regularization to the trained AI model to pre-condition the model for pruning. For example, an L1 regularization may be applied to reduce overfitting in the trained AI model by penalizing the absolute size of the regression coefficients. The pre-conditioned model may be provided to pruning engine 112 to perform a two-stage structured pruning. For example, to squeeze the trained AI model into an MCU’s optimization (resource) constraints (derived by constraint parser 110), model pruning may be performed to eliminate weights (and/or neurons/filters) that contribute little to the model’s predictions, thereby reducing the model size and speeding up inference. Structured pruning, such as channel pruning, can remove entire convolutional filters (and corresponding feature map channels). This is hardware-friendly, as it shrinks the layers of the AI model rather than creating sparse matrices.

As shown in FIGS. 2A-2B, pruning engine 112 may perform a two-stage pruning process, via weight magnitude threshold pruning module 231 and layer-wise sparsity pruning module 232, to methodically trim the trained AI model while preserving accuracy. In the first stage, pruning module 231 may apply a weight magnitude threshold pruning to the AI model to remove the most insignificant weights across all layers of the model. For instance, pruning module 231 may examine the weight magnitudes in each convolutional layer of the trained AI model. Due to regularization, a significant fraction of weights may be close to zero.

Accordingly, pruning module 231 may set a pruning threshold such that any weight with a magnitude below the pruning threshold is zeroed out. For example, a pruning threshold that eliminates approximately 50% of the weights may be chosen initially. In one embodiment, it may be possible to specify a target sparsity or threshold. A toolkit may then prune filters gradually during fine-tuning. In another embodiment, the trained AI model may be directly pruned, which is effectively equivalent to fine-tuning with a pruning mask applied. In some embodiments, many filters in later (deeper) layers may be removed with minimal impact on detection accuracy. This is because deeper layers often learn very class-specific details or redundant features. Pruning module 231 may also analyze layer-specific sparsity. For example, some layers (such as the first convolution layer or first residual block) are crucial and cannot be heavily pruned without hurting accuracy. On the other hand, later layers or wide layers might have more redundancy. Accordingly, pruning module 231 may prune more aggressively in the later layers and maintain earlier layers largely intact. In some embodiments, a higher pruning percentage (sparsity) may be set, e.g., for a fourth residual stage of the AI model (e.g., ResNet-18 model) than for the first stage. After pruning, the model’s parameter count may drop substantially, e.g., by roughly 60%. That is, pruning module 231 may produce a first pruned AI model having a substantially less parameter count as compared to the original trained AI model provided by model trainer 221. For instance, if the original trained model has approximately 5 million parameters, it may have been reduced to approximately 2 million after the first stage pruning. This yielded an immediate benefit: the model file size shrank (e.g., from ~20MB to ~8MB in float32) and inference became faster due to fewer computations.

However, pruning can alter the AI model and can lower accuracy initially because some of the learned capacity have been removed. For example, after the first stage pruning, the mean average precision (mAP) on the validation set may drop by a few points (e.g., from ~49% to ~42%). Therefore, the first pruned AI model may need to relearn to compensate for the removed weights.

Accordingly, as shown in FIG. 2B, pruning module 231 may provide the first pruned AI model to model retrainer 222 to retrain the model and produce a first retrained pruned AI model. In this retraining (stage 1 retrain), model retrainer 222 may use the previous training dataset and hyperparameters (e.g., training dataset 212) to train the first pruned model. However, further regularization may be disabled (turned off) because it is not desirable to push additional weights to zero while the system 103 is attempting to recover accuracy. After retraining, the first retrained pruned model may recover most of its lost accuracy. For example, the mAP may climb back near ~45-46%, which shows that the first retrained pruned model can represent the task well. The remaining weights can be re-optimized to fill in for the removed ones.

The first retrained pruned model may then be provided to pruning module 232 to perform a second stage pruning. In the second stage, pruning module 232 may perform a finer, layer-wise pruning, with more aggressive targets, on the first retrained pruned model to produce a second pruned AI model. That is, with a successfully retrained pruned model, pruning engine 112 may proceed to prune again, using pruning module 232 to push the limits of efficiency. For example, in the second stage pruning, module 232 may evaluate the utilization of each layer of the first retrained pruned model and set specific sparsity targets per layer. This can target layers that are still bottlenecks for runtime or memory. For example, if an early convolution has 64 output channels and it is determined that only 32 are needed, module 232 may prune 50% of that layer. On the other hand, a layer that is already small (e.g., a 3×3 convolution with 16 filters) may be left as-is.

In some embodiments, module 232 may also consider the computational cost of each layer, such as removing filters from a convolution that is applied to a large feature map (early in the model) yields bigger speed gains than pruning the same number of filters from a later layer (which sees a smaller feature map). Thus, the second stage pruning may favor pruning of the middle layers, which may still be operated on moderately sized feature maps and consumed considerable compute. By the end of the second stage pruning, the overall sparsity may be high. For example, the second pruned model may be 75-80% smaller than the original. This translates to a model file that may be under 5MB (in FP32) and fewer ops. In some embodiments, the second pruned model may be fine-tuned again after the second pruning. As will be discussed in more detail below, quantization simulation may be enabled during training. That is, the second pruned model may be provided to QAT trainer 223 to be retrained with QAT.

As described, after pruning, the model may be retrained to regain any lost accuracy. In addition, another optimization may be performed before deployment, such as converting the model to run with integer (INT8) arithmetic. INT8 is the supported precision for AI model (neural network) operations. INT8 inference may use 8-bit integers instead of 32-bit floats, which yields several benefits, such as reduction in model size (e.g., 4x in reduction where each weight/bias may be one byte instead of four), reduction of memory bandwidth, and faster computation since integer operations are cheaper. However, naive post-training quantization (PTQ), which simply rounds a trained float model’s weights to INT8, often causes a drop in accuracy because the quantization process introduces approximation error (especially if weights/activations have a wide dynamic range). Accordingly, to address this issue, QAT trainer 223 may use QAT to simulate the effects of quantization during the training process so the second pruned model can adjust to them.

In QAT, fake quantization nodes may be inserted into a graph. For example, during forward passes, activations and weights are quantized to int8 (with some scale factor) and then de-quantized to float32 for gradient computations. By doing this, in each training iteration, the second pruned model may “sees” the quantization error and can learn to compensate for INT8 rounding error during backpropagation. In other words, QAT produces a model that is already robust to integer arithmetic. In an embodiment, QAT trainer 223 may enable QAT for a final round of training (e.g., another ~100-120 epochs). QAT trainer 223 may re-enabled an L1 regularization during QAT training to keep nudging any remaining unnecessary weights in the second pruned model towards zero. This can help quantization by eliminating tiny weights that would quantize to zero.

After performance of QAT training, the QAT trainer 223 may provide a quantized pruned model to model profiler 113. As described, model profiler 113 may profile the quantized pruned model to provide information about how efficiently the model can run on a target MCU. For example, model profiler 113 may intake the quantized pruned model, examine the memory footprint of the model, and perform operator (op) set compatibility check and latency estimation. Model profiler 113 may measure and determine metrics like resource usage (e.g., NPU/CPU usage), memory consumption, inference latency, throughput, and/or op set compatibility. Based on the metrics, system 103 may determine whether all optimization constraints are satisfied (i.e., the quantized pruned model fits the hardware profile of the MCU). If all optimization constraints are satisfied, the quantized pruned model may be provided to compiler 241. Otherwise, the model may be returned or looped back to pruning module 232 to again perform the second-stage pruning and QAT.

In an embodiment, compiler 241 may convert the model into a highly efficient, custom operator command streams (model operations). For example, an NPU may require model optimization and translation via compiler 241 (e.g., Arm Vela compiler). Compiler 241 may ingest the quantized pruned model, which may be in TFLite file format, and execute computational graph partitioning to allocate operations between the NPU accelerator and a host processor (e.g., RISC ARM processor) when necessary. In some embodiments, the operators (e.g., convolutions, depthwise convolutions, etc.) may be mapped directly to NPU hardware primitives. Compiler 241 may be executed with performance optimization flags. The resultant binary (optimized model) may maintain a lightweight, efficient, and portable model structure (e.g., TFLite file structure), but incorporate hardware-specific optimizations, such as operator fusion, execution scheduling reorganization, and insertion of custom NPU kernels. In an embodiment, compiler 241 may autonomously reconfigure memory allocation strategies, migrating constant memory segments from memory (e.g., SRAM) to storage (e.g., on-chip flash) while preserving memory access characteristics, thus optimizing memory resource utilization.

In an embodiment, verification engine 242 may verify to determine whether the entirety (e.g., 100%) of the operator command streams (model operations) are supported or covered by the target NPU. Note that not all model operations are supported by every NPU. If an op falls back to the CPU, latency target may not be met. If the model operations are not entirely covered by the target NPU or there exists a CPU fallback instance, the optimized model may be returned or looped back to pruning module 232 to again perform the second-stage pruning and QAT. Otherwise, if the model operations are entirely covered on the NPU with zero CPU fallback instances, the optimized model may be provided to hardware binding module 243. In an embodiment, engine 242 may also perform memory budget validation to ensure the size of the model operations (optimized model size) is within the memory budget of the hardware profile. If the model operations is within the memory budget, the optimized model may be provided to module 243 to perform hardware binding. Otherwise, the optimized model may be returned or looped back to pruning module 232 to again perform the second-stage pruning and QAT.

In an embodiment, hardware binding module 243 may perform hardware binding to bind the optimized model to a specific MCU and produce a final optimized model certified and tagged to an identifier, e.g., SKU of the specific MCU. In some embodiments, the hardware binding may produce or generate an artifact package 107 that can be deployed to the MCU with full hardware certification. Artifact package 107 may include a final optimized model 251, an operator coverage report 252, a performance certificate 253, and a memory map 254. In some embodiments, the final optimized model 251 (e.g., Vela-optimized TFLite file) can be executed inferences on the MCU. The operative coverage report 252, which may be in a JavaScript Object Notation (JSON) file format, may include a target SKU, a clock frequency, an op coverage, and/or CPU fallback count. The performance certificate 253, which may also be in JSON format, may include a latency, memory peak size, and/or a bandwidth status (e.g., balanced). The memory map 254, which may also be in JSON format, may include memory area breakdown (e.g., weights stored in on-chip flash, SRAM activations, etc.) and tensor allocation (e.g., tensor allocation table).

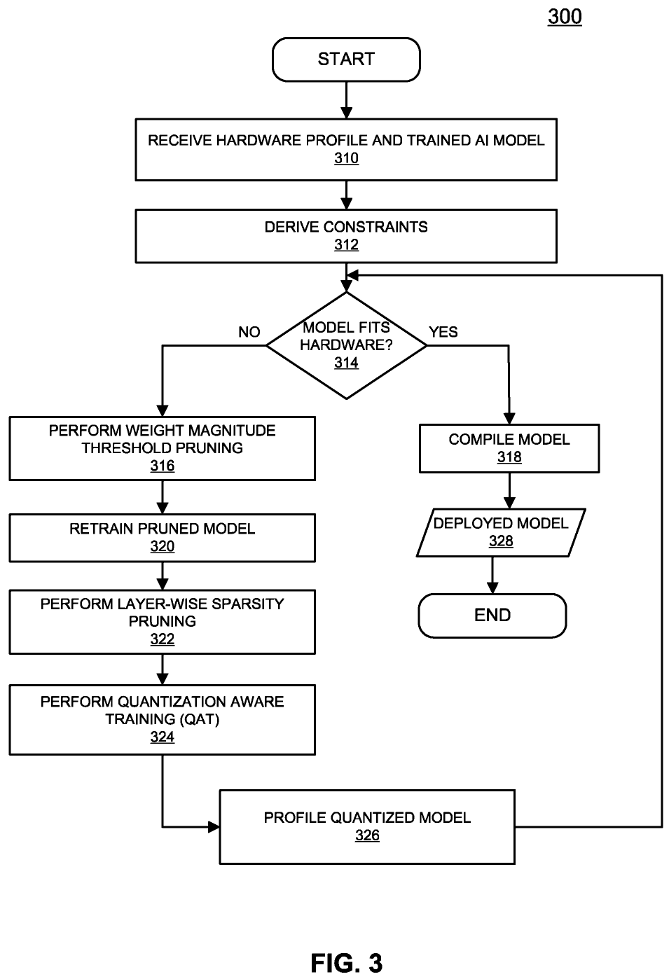

FIG. 3 is a flow diagram illustrating an example process of a closed loop AI model optimization according to an embodiment. Process 300 may be performed by processing logic which may include software, hardware, or a combination thereof. For example, process 300 may be performed by automated AI model optimization system 103 and/or post-processing 105 of FIG. 1.

Referring to FIG. 3, at block 310, the processing logic may receive a hardware profile of a target MCU and a trained AI model. As described, the hardware profile may include a memory budget (e.g., SRAM budget), storage capacity (e.g., flash capacity), NPU architecture (e.g., NPU type, NPU multiply-accumulate (MAC) units, etc.), supported operator set, clock frequency, compute bandwidths (e.g., memory bandwidth and storage bandwidth), etc. The trained model may be trained using a training dataset (e.g., dataset 212 of FIG. 2A), or pretrained on an image database or with a public dataset of images to initialize the AI model with pretrained weights. The trained model may be a machine learning model/algorithm (e.g., deep learning architectures such as deep neural networks, convolutional neural networks, deep belief networks, recurrent neural networks, etc.).

At block 312, the processing logic may derive optimization constraints based on the hardware profile. For example, the processing logic may parse the hardware profile to derive the optimization constraints. The derived optimization constraints may include a maximum activation tensor budget, a maximum model weight budget, supported operation set and tiling strategy, a throughput constraint, a latency budget, an activation scheduling, and/or a constant memory placement.

At block 314, the processing logic may determine whether the trained model fits the hardware profile. For example, the processing logic may determine that the trained model fits the hardware profile if all of optimization constraints are satisfied based on metrics output by a model profiler (e.g., profiler 113 of FIG. 1). In this scenario, the processing logic may proceed to block 318. Otherwise, if any of the optimization constraints is not satisfied, the processing logic may proceed to block 316.

At block 316, the processing logic may perform weight magnitude threshold pruning. As described, a two-stage pruning process may be performed to methodically trim the trained model while preserving accuracy. In the first stage, the weight magnitude threshold pruning may be performed to remove the most insignificant weights across all layers of the trained model and produce a first pruned model. For example, the processing logic may set a pruning threshold such that any weight with a magnitude below the pruning threshold is zeroed out. Aspects of the weight magnitude threshold pruning have been previously described, and for brevity’s sake, will not be described again herein.

At block 320, the processing logic may retrain the first pruned model to produce a retrained pruned model. In this retraining stage, the processing logic may use the previous training dataset (e.g., training dataset 212 of FIG. 2A) to train the first pruned model. However, regularization may be disabled in this retraining stage because it is not desirable to push additional weights to zero while the system is attempting to recover accuracy of the pruned model.

At block 322, the processing logic may perform a layer-wise sparsity pruning of the retrained pruned model to produce a second pruned model. As described, with the retrained pruned model with accuracy recovery, the processing logic may proceed to prune again to push the limits of efficiency. For example, the processing logic may evaluate the utilization of each layer of the first retrained pruned model and set specific sparsity targets per layer. This can target layers that are still bottlenecks for runtime or memory. For example, if an early convolution has 64 output channels and it is determined that only 32 are needed, the processing logic may prune 50% of that layer. On the other hand, a layer that is already small (e.g., a 3×3 convolution with 16 filters) may be left alone.

At block 324, the processing logic may perform QAT on the second pruned model to produce a quantized model. Aspects of the QAT have been previously described, and for brevity’s sake, will not be described again herein. Accordingly, by pruning gradually and allowing the model to recover accuracy in between via retraining, model performance can be maintained while drastically reducing complexity.

At block 326, the processing logic may profile the quantized model to provide information about how efficiently the quantized model can be run on a target MCU. For example, the processing logic may analyze the quantized model’s performance, resource utilization, and behavior during training or inference to identify bottlenecks. The processing logic may measure metrics such as processor usage (e.g., NPU/CPU usage), memory consumption, latency, and/or op set compatibility. The metrics may be provided to block 314 for comparison with the derived constraints to determine whether all constraints are satisfied (as previously described).

At block 318, the processing logic may compile the quantized model. For example, the processing logic may ingest the quantized model (e.g., TFLite file) and execute computational graph partitioning to allocate operations between the NPU accelerator and a host processor (e.g., RISC ARM processor) when necessary. In some embodiments, the operators (e.g., convolutions, depthwise convolutions, etc.) may be mapped directly to NPU hardware primitives. The resultant binary (deployed model 328) may maintain a lightweight, efficient, and portable model structure (e.g., TFLite file structure), but incorporate hardware-specific optimizations, such as operator fusion, execution scheduling reorganization, and insertion of custom NPU kernels.

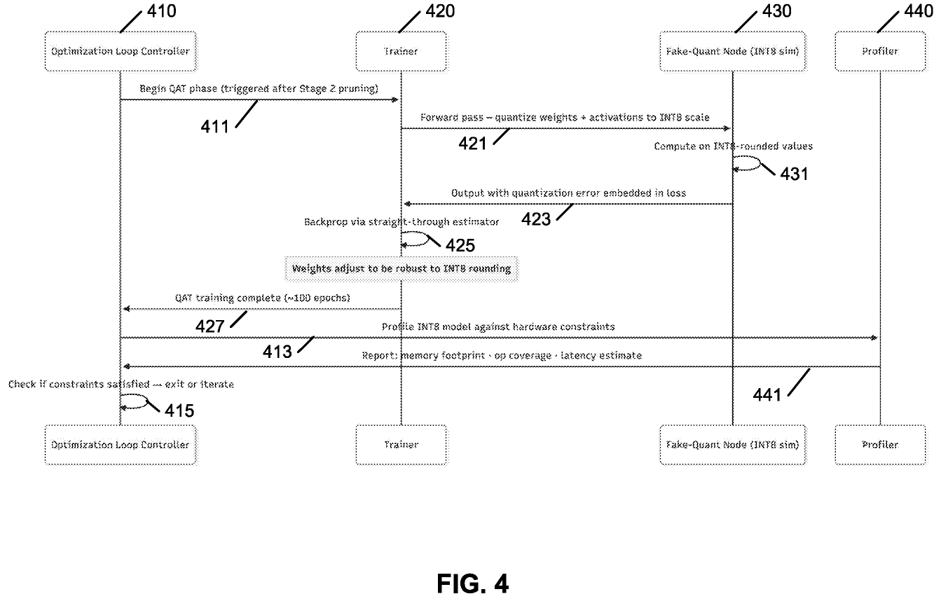

FIG. 4 is a sequence diagram illustrating actions for QAT in an automated AI model optimization system according to an embodiment. Referring to FIG. 4, optimization loop controller 410 may send a pruned model (triggered after a second stage pruning) to trainer 420 to begin a QAT phase (arrow 411). During a forward pass, trainer 420 may quantize activations and weights to int8 scale and provide int8-rounded values to fake quantization node 430 (arrow 421). Fake quantization node 430 may compute on the int8-rounded values (arrow 431) then send an output with quantization error embedded in loss to trainer 420 (arrow 423). During backpropagation (arrow 425), the pruned model (trained by trainer 420) may “sees” the quantization error and adjust the weights to be robust to int8 rounding. When QAT training is complete, trainer 420 may send a quantized model to operation loop controller 410 (arrow 427). Operation loop controller 410 may then send the quantized model to profiler 440 to profile the quantized model against hardware (derived) constraints (arrow 413). Profiler 440 may analyze the performance of the quantized model, generate a profile report of the model, and send the report to optimization loop controller 410 (arrow 441). The profile report may include a memory footprint, op coverage and latency estimate of the model. Based on the report, optimization loop controller 410 may check to determine whether all constraints are satisfied (arrow 415). If all constraints are satisfied, operation loop controller 410 may exit the loop. Otherwise, controller 410 may iterate and perform the second stage pruning.

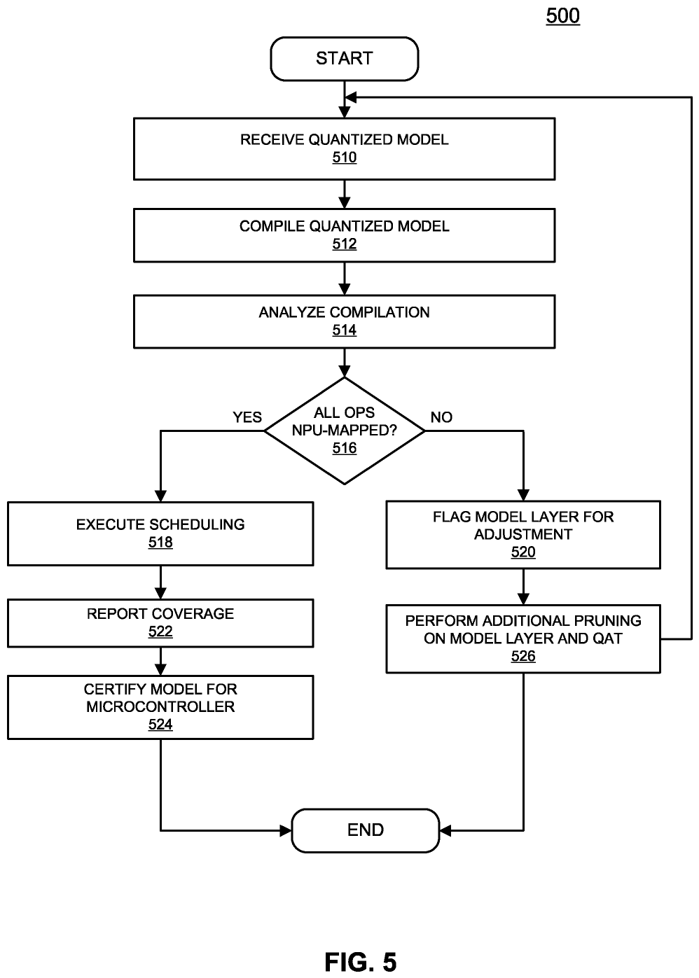

FIG. 5 is a flow diagram illustrating an example process of verifying NPU operator compatibility according to an embodiment. Process 500 may be performed by processing logic which may include software, hardware, or a combination thereof. For example, process 300 may be performed by post-processing 105 of FIG. 1.

At block 510, the processing logic may receive a quantized AI model. As described, the quantized model may be generated by performing the second stage (layer-wise sparsity) pruning followed by QAT.

At block 512, the processing logic may compile the quantized model. For example, the processing logic may ingest the quantized model (e.g., TFLite file), and execute computational graph partitioning to allocate operations between the NPU accelerator and a host processor (e.g., RISC ARM processor).

At block 514, the processing logic may analyze the compilation to determine whether the operators (e.g., convolutions, depthwise convolutions, etc.) are mapped to NPU hardware primitives.

At block 516, if all ops have been NPU-mapped, the processing logic proceeds to block 518. Otherwise, the processing logic proceeds to block 520.

At block 518, the processing logic may execute scheduling. For example, the processing logic may perform operator fusion to merge multiple operators into a single kernel to execute them together in order to reduce memory overhead. The processing logic may perform tiling memory placement that divides large tensors into tiles that can be fit within a memory (e.g., SRAM).

At block 522, the processing logic may report coverage that may include NPU ops coverage (e.g., 100%), CPU fallback count (e.g., 0), memory bandwidth (e.g., SRAM bandwidth), and storage bandwidth (e.g., flash bandwidth).

At block 524, the processing logic may certify the model for the MCU. For example, hardware binding may be performed to bind the optimized model to a specific MCU and produce a final optimized model certified and tagged to an identifier, e.g., SKU, of the specific MCU.

At block 520, the processing logic may flag a layer of the quantized model for adjustment. For example, the processing logic may evaluate the utilization of each layer of the quantized model and set specific sparsity targets per layer. This can target layers that are still bottlenecks for runtime or memory. For example, if an early convolution has 64 output channels and it is determined that only 32 are needed, 50% of that layer may be pruned. On the other hand, a layer that is already small (e.g., a 3×3 convolution with 16 filters) may be left as-is.

At block 526, the processing logic may perform additional pruning on the flagged layer (second stage pruning) and perform QAT on the pruned model. Aspects of the second stage pruning and QAT have been previously described, and for brevity’s sake, will not be described again herein.

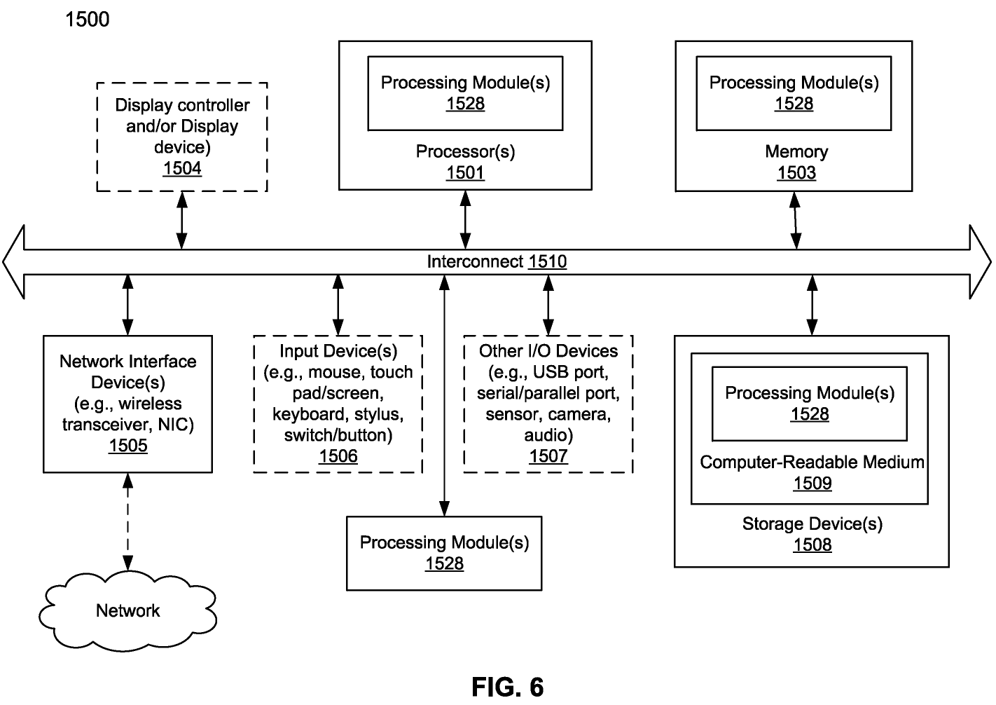

FIG. 6 is a block diagram illustrating an example of a data processing system which may be used with one embodiment of the disclosure. For example, system 1500 may represent any of data processing systems described above performing any of the processes or methods described above, such as, for example, constraint parser 110, training subsystem 111, pruning engine 112, model profiler 113 and post-processing 105 of FIG. 1. System 1500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system.

Note also that system 1500 is intended to show a high-level view of many components of the computer system. However, it is to be understood that additional components may be present in certain implementations and furthermore, different arrangement of the components shown may occur in other implementations. System 1500 may represent a desktop, a laptop, a tablet, a server, a mobile phone, a media player, a personal digital assistant (PDA), a Smartwatch, a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 1500 includes processor 1501, memory 1503, and devices 1505-1508 connected via a bus or an interconnect 1510. Processor 1501 may represent a single processor or multiple processors with a single processor core or multiple processor cores included therein. Processor 1501 may represent one or more general-purpose processors such as a microprocessor, a graphics processing unit (GPU), a central processing unit (CPU), or the like. More particularly, processor 1501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 1501 may also be one or more special-purpose processors such as an application specific integrated circuit (ASIC), a cellular or baseband processor, a field programmable gate array (FPGA), a digital signal processor (DSP), a network processor, a graphics processor, a communications processor, a cryptographic processor, a co-processor, an embedded processor, or any other type of logic capable of processing instructions.

Processor 1501, which may be a low power multi-core processor socket such as an ultra-low voltage processor, may act as a main processing unit and central hub for communication with the various components of the system. Such processor can be implemented as a system on chip (SoC). Processor 1501 is configured to execute instructions for performing the operations and steps discussed herein. System 1500 may further include a graphics interface that communicates with optional graphics subsystem 1504, which may include a display controller, a graphics processor, and/or a display device.

Processor 1501 may communicate with memory 1503, which in one embodiment can be implemented via multiple memory devices to provide for a given amount of system memory. Memory 1503 may include one or more volatile storage (or memory) devices such as random access memory (RAM), dynamic RAM (DRAM), synchronous DRAM (SDRAM), static RAM (SRAM), or other types of storage devices. Memory 1503 may store information including sequences of instructions that are executed by processor 1501, or any other device. For example, executable code and/or data of a variety of operating systems, device drivers, firmware (e.g., input output basic system or BIOS), and/or applications can be loaded in memory 1503 and executed by processor 1501. An operating system can be any kind of operating systems, such as, for example, Robot Operating System (ROS), Windows^{®} operating system from Microsoft^{®}, Mac OS/iOS^{®} from Apple, Android^{®} from Google^{®}, LINUX, UNIX, or other real-time or embedded operating systems.

System 1500 may further include IO devices such as devices 1505-1508, including network interface device(s) 1505, optional input device(s) 1506, and other optional IO device(s) 1507. Network interface device 1505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 1506 may include a mouse, a touch pad, a touch sensitive screen (which may be integrated with display device 1504), a pointer device such as a stylus, and/or a keyboard (e.g., physical keyboard or a virtual keyboard displayed as part of a touch sensitive screen). For example, input device 1506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 1507 may include an audio device. An audio device may include a speaker and/or a microphone to facilitate voice-enabled functions, such as voice recognition, voice replication, digital recording, and/or telephony functions. Other IO devices 1507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Devices 1507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 1510 via a sensor hub (not shown), while other devices such as a keyboard or thermal sensor may be controlled by an embedded controller (not shown), dependent upon the specific configuration or design of system 1500.

To provide for persistent storage of information such as data, applications, one or more operating systems and so forth, a mass storage (not shown) may also couple to processor 1501. In various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 1501, e.g., via a serial peripheral interface (SPI). This flash device may provide for non-volatile storage of system software, including BIOS as well as other firmware of the system.

Storage device 1508 may include computer-accessible storage medium 1509 (also known as a machine-readable storage medium or a computer-readable medium) on which is stored one or more sets of instructions or software (e.g., module, unit, and/or logic 1528) embodying any one or more of the methodologies or functions described herein. Processing module/unit/logic 1528 may represent any of the components described above, such as, for example, constraint parser 110, training subsystem 111, pruning engine 112, model profiler 113, post-processing 105, and the modules, engines or units in system architecture 100 of FIG. 1 as previously described. Processing module/unit/logic 1528 may also reside, completely or at least partially, within memory 1503 and/or within processor 1501 during execution thereof by data processing system 1500, memory 1503 and processor 1501 also constituting machine-accessible storage media. Processing module/unit/logic 1528 may further be transmitted or received over a network via network interface device 1505.

Computer-readable storage medium 1509 may also be used to store some software functionalities described above persistently. While computer-readable storage medium 1509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media, or any other non-transitory machine-readable medium.

Processing module/unit/logic 1528, components and other features described herein can be implemented as discrete hardware components or integrated in the functionality of hardware components such as ASICS, FPGAs, DSPs or similar devices. In addition, processing module/unit/logic 1528 can be implemented as firmware or functional circuitry within hardware devices. Further, processing module/unit/logic 1528 can be implemented in any combination hardware devices and software components.

Note that while system 1500 is illustrated with various components of a data processing system, it is not intended to represent any particular architecture or manner of interconnecting the components, as such details are not germane to embodiments of the present disclosure. It will also be appreciated that network computers, handheld computers, mobile phones, servers, and/or other data processing systems which have fewer components or perhaps more components may also be used with embodiments of the disclosure.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method of artificial intelligence (AI) model optimization, comprising:
obtaining a hardware profile of a microcontroller unit (MCU);
deriving a plurality of constraints based on the hardware profile;
training a baseline AI model using a training dataset, to produce a trained model;
performing a first pruning on the trained model, to produce a first pruned model;
retraining the first pruned model using the training dataset, to produce a retrained pruned model;
performing a second pruning on the retrained pruned model, to produce a second pruned model; and
retraining the second pruned model to produce a quantized pruned model.

2. The method of claim 1, further comprising: prior to performing the first pruning on the trained model, applying regularization on the trained model.

3. The method of claim 1, further comprising:
profiling the quantized pruned model to determine a plurality of metrics associated with the quantized pruned model; and
determining whether all of the plurality of constraints are satisfied based on the plurality of metrics.

4. The method of claim 3, further comprising:
in response to determining that all of the plurality of constraints are satisfied, optimizing the quantized pruned model to produce a final optimized model, wherein the final optimized model is deployable on a target neural processing unit (NPU) of the MCU.

5. The method of claim 4, wherein optimizing the quantized pruned model comprises:
converting the quantized pruned model into an optimized model,
verifying that the optimized model is supported by the target NPU,
performing memory budget validation to ensure a size of the optimized model is within a memory budget of the hardware profile, and
performing hardware binding to bind the optimized model to the MCU, to produce the final optimized model that is certified and tagged to an identifier of the MCU.

6. The method of claim 3, further comprising:
in response to determining that at least one of the plurality of constraints is not satisfied, performing the second pruning on the quantized model to produce a third pruned model, and retraining the third pruned model to produce a further quantized pruned model.

7. The method of claim 1, wherein performing the first pruning comprises: zeroing out one or more of a plurality of weight magnitudes across a plurality of layers of the trained model based on a pruning threshold.

8. The method of claim 1, wherein performing the second pruning comprises:
evaluating a utilization of each layer of the retrained pruned model, and
pruning a portion of the layer based on a sparsity target set for the layer.

9. The method of claim 1, wherein the second pruned model is retrained using quantization aware training (QAT).

10. The method of claim 1, wherein the hardware profile comprises at least one of: a memory budget, a storage capacity, neural processing unit (NPU) architecture, supported operator set, clock frequency, or compute bandwidths.

11. A non-transitory computer readable storage medium including instructions that, when executed by a processor, cause the processor to perform operations comprising:
obtaining a hardware profile of a microcontroller unit (MCU);
deriving a plurality of constraints based on the hardware profile;
training a baseline AI model using a training dataset, to produce a trained model;
performing a first pruning on the trained model, to produce a first pruned model;
retraining the first pruned model using the training dataset, to produce a retrained pruned model;
performing a second pruning on the retrained pruned model, to produce a second pruned model; and
retraining the second pruned model to produce a quantized pruned model.

12. The non-transitory computer readable storage medium of claim 11, wherein the operations further comprise: prior to performing the first pruning on the trained model, applying regularization on the trained model.

13. The non-transitory computer readable storage medium of claim 11, wherein the operations further comprise:
profiling the quantized pruned model to determine a plurality of metrics associated with the quantized pruned model; and
determining whether all of the plurality of constraints are satisfied based on the plurality of metrics.

14. The non-transitory computer readable storage medium of claim 13, wherein the operations further comprise:
in response to determining that all of the plurality of constraints are satisfied, optimizing the quantized pruned model to produce a final optimized model, wherein the final optimized model is deployable on a target neural processing unit (NPU) of the MCU.

15. The non-transitory computer readable storage medium of claim 14, wherein optimizing the quantized pruned model comprises:
converting the quantized pruned model into an optimized model,
verifying that the optimized model is supported by the target NPU,
performing memory budget validation to ensure a size of the optimized model is within a memory budget of the hardware profile, and
performing hardware binding to bind the optimized model to the MCU, to produce the final optimized model that is certified and tagged to an identifier of the MCU.

16. The non-transitory computer readable storage medium of claim 13, wherein the operations further comprise:
in response to determining that at least one of the plurality of constraints is not satisfied, performing the second pruning on the quantized model to produce a third pruned model, and retraining the third pruned model to produce a further quantized pruned model.

17. The non-transitory computer readable storage medium of claim 11, wherein performing the first pruning comprises: zeroing out one or more of a plurality of weight magnitudes across a plurality of layers of the trained model based on a pruning threshold.

18. The non-transitory computer readable storage medium of claim 11, wherein performing the second pruning comprises:
evaluating a utilization of each layer of the retrained pruned model, and
pruning a portion of the layer based on a sparsity target set for the layer.

19. The non-transitory computer readable storage medium of claim 11, wherein the second pruned model is retrained using quantization aware training (QAT).

20. A system for artificial intelligence (AI) model optimization, the system comprising:
a processor; and
a memory coupled to the processor to store instructions, which when executed by the processor, cause the processor to perform operations comprising:
obtaining a hardware profile of a microcontroller unit (MCU);
deriving a plurality of constraints based on the hardware profile;
training a baseline AI model using a training dataset, to produce a trained model;
performing a first pruning on the trained model, to produce a first pruned model;
retraining the first pruned model using the training dataset, to produce a retrained pruned model;
performing a second pruning on the retrained pruned model, to produce a second pruned model; and
retraining the second pruned model to produce a quantized pruned model.
